(19) United States
(12) Patent Application Publication
(10) Pub. No.: US 2026/0046517 A1
(43) Pub. Date: Feb. 12, 2026

(54) CAMERA DEVICE AND FOCUS SETTING METHOD

(71) Applicant: HANWHA VISION CO., LTD., Seongnam-si (KR)

(72) Inventors: Dong Jin PARK, Seongnam-si (KR); Dae Bong KIM, Seongnam-si (KR)

(73) Assignee: HANWHA VISION CO., LTD., Seongnam-si (KR)

(21) Appl. No.: 19/360,350

(22) Filed: Oct. 16, 2025

Related U.S. Application Data
(63) Continuation of application No. PCT/KR2024/004589, filed on Apr. 8, 2024.

(30) Foreign Application Priority Data
Apr. 25, 2023 (KR) 10-2023-0053828
Apr. 3, 2024 (KR) 10-2024-0045392

(51) Int. Cl. H04N 23/67; G02B 7/105; G02B 7/28; G02B 7/36; H04N 23/68

(52) U.S. Cl. CPC H04N 23/671; G02B 7/105; G02B 7/282; G02B 7/365; H04N 23/675; H04N 23/687

(57) ABSTRACT

A camera device includes: a lens configured to receive light incident from a subject; an image sensor configured to capture an image of the subject using the received light; a distance measurer configured to identify a plurality of positions having same distance information in the image; a window setter configured to set one or more focus windows in the image based on the plurality of positions; a focus position estimator configured to determine a focus position for capturing the image using pixels within the one or more focus windows; and a lens controller configured to control a position of the lens according to the determined focus position.

### CROSS-REFERENCE TO RELATED APPLICATION(S)

This application is a continuation of International Application No. PCT/KR2024/004589, filed on Apr. 8, 2024, in the Korean Intellectual Property Receiving Office, which is based on and claims priority to Korean Patent Application No. 10-2023-0053828, filed on Apr. 25, 2023 and Korean Patent Application No. 10-2024-0045392, filed on Apr. 3, 2024, in the Korean Intellectual Property Office, the disclosures of which are incorporated by reference herein in their entireties.

### BACKGROUND

### 1. Field

The present disclosure relates to a technology for setting a focus of a camera, and more particularly, to a method and apparatus for setting a focus of a camera more accurately by using distance information in an image currently being captured.

### 2. Description of Related Art

Generally, camera devices provide a function that allows a user to manually set a focus value (focus position) for a specific scene or a function that automatically sets a focus through analysis of the scene. Among these, the latter function is called auto-focusing (AF).

A distance (between a lens and a subject) may be different at various positions in an image being captured. Therefore, in the image, an area serving as a reference for auto-focusing, that is, a focus window (AF window), must be set.

The size of the focus window may be determined in advance according to the zoom step of a camera, or continuous auto-focusing (CAF) may be executed by selecting only appropriate data in units of blocks with reference to image data to which auto-focusing is applied.

However, when the focus of the camera is near zoom wide position at which the zoom magnification is small, it is common to set the focus window small because there is a large difference in distance within an image. This is to focus on a position where the shaking of a captured image is minimized because a change in focus according to a unit zoom step is large at that magnification.

However, as the size of the focus window decreases, the amount of data used for auto-focusing also decreases. Therefore, the performance of auto-focusing is greatly affected by data in a narrow area.

Therefore, there is a need to develop auto-focusing technology that can prevent quality degradation of a captured image even under image capturing conditions where there is a small focus window.

### SUMMARY

Provided are a focus setting method and a camera device which improve auto-focusing performance by increasing the amount of data utilized for auto-focusing by using a plurality of focus windows under image capturing conditions which use a small focus window.

However, aspects of the present disclosure are not restricted to the one set forth herein. Additional aspects will be set forth in part in the description which follows and, in part, will be apparent from the description, or may be learned by practice of the presented embodiments.

According to an embodiment of the disclosure, a camera device may include: a lens configured to receive light incident from a subject; an image sensor configured to capture an image of the subject using the received light; a distance measurer configured to identify a plurality of positions having same distance information in the image; a window setter configured to set one or more focus windows in the image based on the plurality of positions; a focus position estimator configured to determine a focus position for capturing the image using pixels within the one or more focus windows; and a lens controller configured to control a position of the lens according to the determined focus position.

The window setter may be further configured to set a plurality of focus windows to be spaced apart from each other without overlapping.

The camera device may further include an image determinator configured to determine a type of the image, where the focus position estimator is further configured to: determine the focus position using a plurality of focus windows based on the type of the image satisfying a predetermined condition; and determine the focus position using a single focus window based on the type of the image not satisfying the predetermined condition.

The predetermined condition may be satisfied based on the image being captured under a low-illumination condition or at a zoom-wide magnification condition.

The low-illumination condition may be satisfied based on an illumination sensor value exceeding a first reference value or based on a sensor gain value being less than or equal to a second reference value.

The distance information may include at least one of an absolute distance obtained through a time of flight (ToF) of electromagnetic waves, and a distance for each of a plurality of areas within the image that is stored through pre-calibration.

The distance information may be obtained through learning of the image, and the image used as input for the learning may be an image that is down-sampled from the captured image or cropped from the captured image.

The distance measurer may be further configured to obtain the distance information in units of areas or pixels within the captured image by matching the distance information obtained through the learning with the captured image.

The window setter may be further configured to variably set a number of focus windows by increasing the number of focus windows until an amount of image information obtained from the one or more focus windows exceeds a threshold.

The window setter may be further configured to set the one or more focus windows within a distance range obtained by modifying a margin from the distance information.

The window setter may be further configured to set a focus window having high-frequency components in an amount equal to or greater than a reference value as the one or more focus windows, and exclude a focus window having the high-frequency components in an amount less than the reference value.

The window setter may be further configured to set a focus window whose average brightness is equal to higher than a reference value as the one or more focus windows, and exclude a focus window whose average brightness is lower than the reference value.

The distance measurer may be further configured to calculate a distribution value of a plurality of pieces of distance information within the captured image, where the focus position estimator is further configured to: determine the focus position using a plurality of focus windows based on the distribution value exceeding a reference value, and determine the focus position using a single focus window based on the distribution value being equal to or less than the reference value.

According to an embodiment of the disclosure, provided is a focusing setting method performed by a camera device, the method may include: capturing an image of a subject using an image sensor; identifying a plurality of positions having same distance information in the image; setting one or more focus windows in the image based on the plurality of positions; determining a focus position for capturing the image using pixels within the one or more focus windows; and controlling a position of a lens according to the determined focus position.

The method may further include determining a type of the image, where the determining of the focus position includes: determining the focus position using a plurality of focus windows based on the type of the image satisfying a predetermined condition; and determining the focus position using a single focus window based on the type of the image not satisfying the predetermined condition.

The distance information may be obtained through learning of the image, and an image used as input for the learning may be an image that is down-sampled from the captured image or cropped from the captured image.

The setting the one or more focus windows may include variably setting a number of focus windows by increasing the number of focus windows until an amount of image information obtained from the one or more focus windows exceeds a threshold.

The setting the one or more focus windows may further include setting the one or more focus windows within a distance range obtained by modifying a margin from the distance information.

The setting the one or more focus windows may include setting a focus window having high-frequency components in an amount equal to or greater than a reference value as the one or more focus windows, and excluding a focus window having the high-frequency components in an amount less than the reference value.

The setting the one or more focus windows may include setting a focus window whose average brightness is equal to higher than a reference value as the one or more focus windows, and excluding a focus window whose average brightness is lower than the reference value.

According to an embodiment of the disclosure, a non-transitory computer-readable storage medium may store instructions that, when executed by at least one processor of a camera device, cause the camera device to: capture an image of a subject using an image sensor; identify a plurality of positions having same distance information in the image; set one or more focus windows in the image based on the plurality of positions; determine a focus position for capturing the image using pixels within the one or more focus windows; and control a position of a lens according to the determined focus position.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a camera device according to an embodiment of the present disclosure;

FIG. 2 illustrates a process of generating a depth estimation image through monocular depth estimation according to an embodiment of the present disclosure;

FIG. 3 illustrates a state in which focus windows are respectively set at a plurality of positions at the same distance within a captured image according to an embodiment of the present disclosure;

FIG. 4 illustrates a process of finding an optimal focus position according to an embodiment of the present disclosure;

FIG. 5 is a graph of locus data showing a change in focus position at a specific magnification according to an embodiment of the present disclosure;

FIG. 6 illustrates a state in which focus windows are respectively set at a plurality of positions at the same distance as an object of interest when a user sets the object of interest within a captured image according to an embodiment of the present disclosure;

FIG. 7 illustrates a process of calculating a distribution value of a plurality of pieces of distance information within a captured image according to an embodiment of the present disclosure;

FIG. 8 illustrates a state in which the number of focus windows shown in FIG. 6 has increased according to an embodiment of the present disclosure;

FIG. 9 illustrates the hardware configuration of a computing device that realizes the camera device of FIG. 1 according to an embodiment of the present disclosure; and

FIG. 10 is a flowchart schematically illustrating a method of generating distance information according to an embodiment of the present disclosure.

### DETAILED DESCRIPTION

Advantages and features of the disclosure and methods to achieve them will become apparent from the descriptions of exemplary embodiments herein below with reference to the accompanying drawings. However, the disclosure is not limited to exemplary embodiments disclosed herein but may be implemented in various ways. The exemplary embodiments for conveying the scope of the disclosure to those skilled in the art, but the scope of the disclosure is not limited thereto. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustrating the embodiments rather than limiting the present disclosure. As used herein, the singular forms are intended to include plural forms as well, unless the context clearly indicates otherwise. Throughout this specification, the word “comprise,” “include,” “has,” and variations such as “comprises,” “comprising,” “includes,” “including,” “having,” and the like, will be understood to imply the inclusion of stated elements but not the exclusion of any other elements.

Hereinafter, exemplary embodiments of the present disclosure will be described in detail with reference to the accompanying drawings.

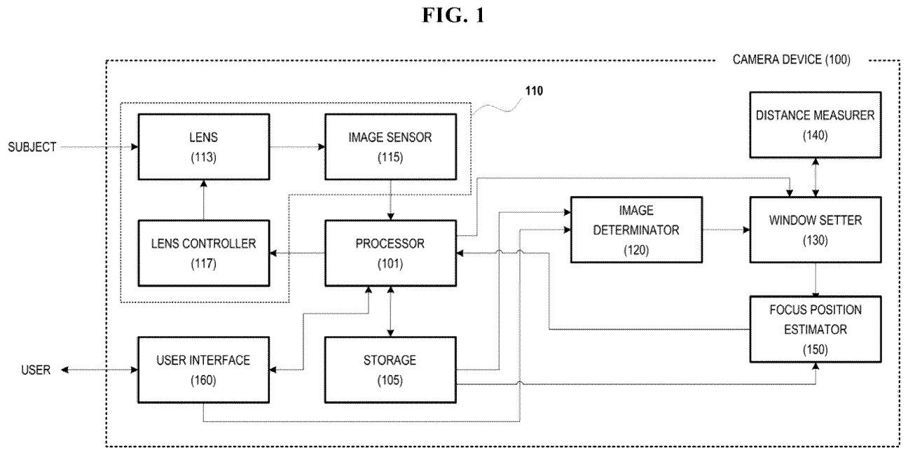

FIG. 1 is a block diagram of a camera device 100 according to an embodiment of the present disclosure. The camera device 100 may include a processor 101, a storage 105, an imaging device 110, an image determinator 120, a window setter 130, a distance measurer 140, a focus position estimator 150, and a user interface 160.

The processor 101 may serve as a controller that controls the operations of other elements of the camera device 100 and may generally be implemented as a central processing unit (CPU), a microprocessor, etc. The processor 101 may include at least one processor. In addition, the storage 105 may be a storage medium that stores the results of operations performed by the processor 101 or data necessary for the operation of the processor 101, for example, program instructions executed by the processor 101. The storage 105 may be implemented as a volatile memory or a nonvolatile memory.

The image determinator 120, the window setter 130, the distance measurer 140, and/or the focus position estimator 150 may be implemented by computer code or instructions which may be stored in the storage 105, the processor 101 may load the computer code or instructions to the internal memory and execute the computer code or instructions to perform the functions of these components described herebelow. Alternatively or additionally, the image determinator 120, the window setter 130, the distance measurer 140, and/or the focus position estimator 150 may be implemented by dedicated hardware including one or more of logic gates or circuits, registers, memories, interface circuits, etc. configured to perform the functions described herebelow in association with the processor 101.

The imaging device 110 may include an optical system or lens 113, an image sensor 115, and a lens controller 117. The optical system or lens may be configured to be opened or closed by a shutter and receive light reflected from a subject while the shutter is open. The image sensor 115 may capture an image by capturing the received light and outputting the captured light as an electrical signal. The image sensor 115 may be implemented as a complementary metal-oxide-semiconductor (CMOS) device or a charge-coupled device (CCD). The lens controller 117 may be configured to adjust the position (zoom direction position) of the lens 113 under the control of the processor 101. The lens controller 117 may include at least one actuator. The captured image can be displayed as an analog signal or a digital signal. The digital signal may be provided to the processor 101 after being preprocessed by an image processing unit or an image signal processor (ISP) and may be temporarily or permanently stored in the storage 105.

The user interface 160 may have a function of interacting with a user, such as, receiving a specific command from the user or displaying related information to the user. To this end, the user interface 160 may include both an input interface and an output interface. The input interface may be implemented as a mouse, a keyboard, a voice recognition device, a motion recognition device, or the like. The output interface may be implemented as a display device such as a light emitting diode (LED) or a liquid crystal display (LCD), a speaker, a haptic device, or the like. Alternatively, the user interface 160 may be a device equipped with combined input/output interface, such as a touch screen.

A user may input, through the user interface 160, a command to designate a specific position as an area of interest in an image being captured. In addition, the user may check the image currently being captured and a plurality of focus windows displayed on the image through the user interface 160 and thus may check the image being zoomed in or out in real time. According to an embodiment, the user may check distance information of the focus windows displayed on the image or may select a focus window to be used for estimating a focus position by removing some of the focus windows.

The image determinator 120 may determine the type of the captured image. The operation of the window setter 130 may vary depending on the type of the image determined by the image determinator 120. For example, depending on the determined type of the image, a first mode for estimating a focus position based on a single focus window or a second mode for estimating a focus position based on a plurality of focus windows may be determined (hereinafter, referred to as a second embodiment). However, if the camera device 100 does not include the image determinator 120, or if the image determinator 120 is otherwise not functioning in the camera device 100, the window setter 130 may operate only in the second mode for estimating a focus position based on a plurality of focus windows (hereinafter, referred to as a first embodiment).

The first embodiment will now be described first.

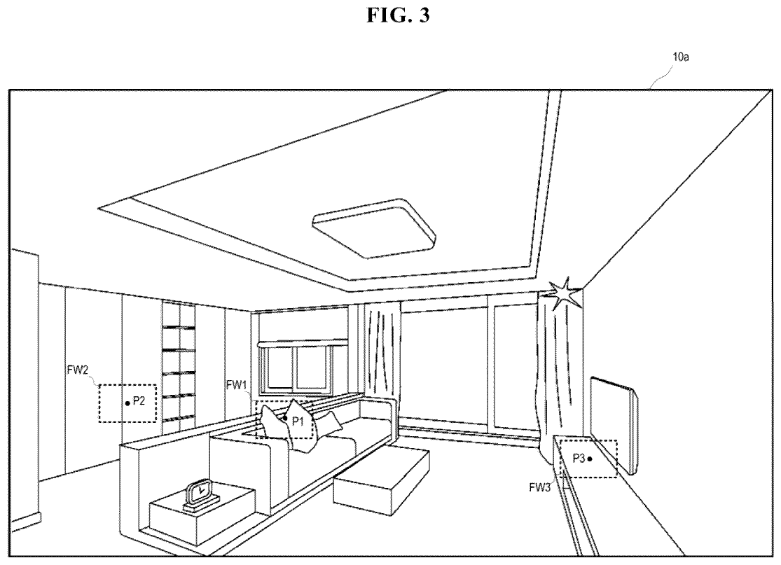

The distance measurer 140 may identify a plurality of positions (see P1, P2 and P3 in FIG. 3) having the same distance information in the captured image. In the present disclosure, distance information refers to a distance from the lens 113 of the camera device 100 to a subject. The distance information may vary depending on the position within the image. The distance information may include a concept that encompasses a relative distance obtained through monocular depth estimation (MDE), an absolute distance obtained through time of flight (ToF) of electromagnetic waves, and a distance for each area stored through pre-calibration. However, these are merely example methods of acquiring the distance information, and the disclosure is not limited thereto.

First, a method of obtaining an absolute distance through the ToF of electromagnetic waves may include a method in which, for example, a light emitter and a light receiver of a light detection and ranging type (LiDAR) or laser type are attached in a direction parallel to the lens 113 of the imaging device 110, and a distance is measured using a time difference when light emitted from the light emitter is reflected from a subject and enters the light receiver.

In addition, the pre-calibration method may include a method in which a captured image is divided into a plurality of areas, distance information for each area is obtained and stored, and the stored distance information is utilized. In order to obtain the distance information for each area, various methods can be used, such as using a distance measuring device or estimating a focus position for each area. The pre-calibration method makes it possible to, when focusing on a specific position (area) in an image, immediately identify other positions having the same distance information as the specific position by using the stored distance information for each area without additional measurement or calculation.

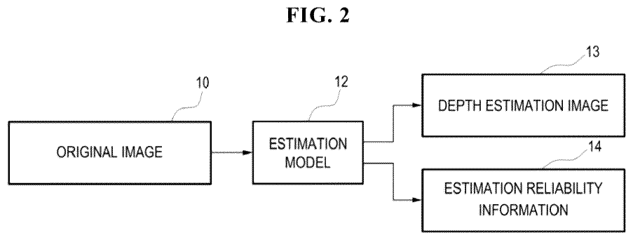

In addition, monocular depth estimation is known as a technology for estimating a distance using only a combination of a single optical system and an image sensor. For example, referring to FIG. 2, an original image 10 may be a two-dimensional image captured by a camera. The original image 10 may be an image captured by a monocular camera. An estimation model 12 based on a deep learning algorithm may be a model that receives a monocular image and outputs depth information corresponding to each pixel within the image.

A depth of an image may be a value based on a distance between a camera that captured the image and an object in the image. The depth of the image may be expressed in units of pixels of the image. For example, the depth of the image may be expressed as a depth map that includes a value representing a depth of each pixel included in the image. The depth map refers to one image or one channel of an image that contains information related to a distance from an observation viewpoint to the surface of an object. For example, the depth map may be a data structure that stores a value representing a depth corresponding to each pixel in the image and has a size corresponding to the number of pixels in the image. Through the depth map, an image that visualizes the value representing the depth corresponding to each pixel in the image in grayscale, that is, a depth estimation image 13, can be obtained. The depth estimation image 13 may be a first statistical value representing information about an estimated depth value of each pixel. A second statistical value, which is another output corresponding to the first statistical value, is estimation reliability information 14 about the depth of each pixel and may be provided in a one-to-one correspondence with the depth estimation image 13.

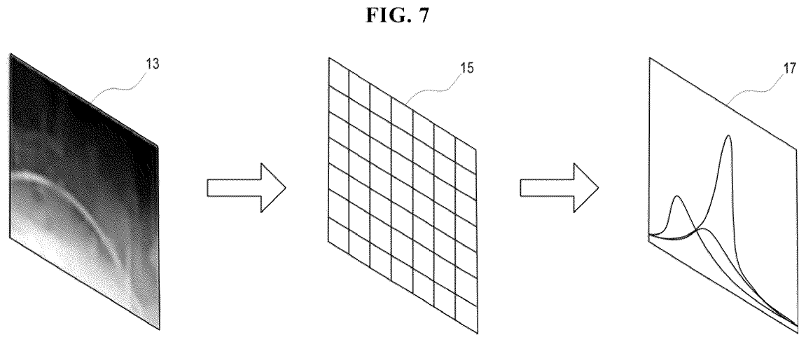

Distance information obtained according to monocular depth estimation as described above may be a relative distance. That is, a depth map (see 13 in FIG. 7) obtained according to monocular depth estimation may be displayed in grayscale, and the brightness of a pixel represents a distance. Therefore, distances can be relatively compared by area. In the present disclosure, monocular depth estimation is only one example of obtaining the distance information through analysis of an image itself. In another example, a relative distance or an absolute distance can be obtained through artificial intelligence (AI) learning (deep learning) of an image itself.

Therefore, in the present disclosure, distance information obtained through analysis of an image itself may be a relative distance or an absolute distance obtained through AI learning or may be a relative distance obtained through monocular depth estimation. In either case, input and learning (machine learning or estimation) of a large number of sample images may be required to obtain distance information for an arbitrary image. If a sample image having the same resolution as an original image is used, an excessive amount of computation can be a problem. Therefore, in the present disclosure, an image (a sample image) used as input for the above learning uses an image down-sampled from the captured image or cropped from the captured image.

The distance measurer 140 may obtain distance information in units of areas or pixels within a captured image by matching the distance information obtained through the above learning (e.g., output of an MDE estimation model or an AI model) with the captured image again. Generally, the distance measurer 140 may preprocess (down-sample, down-scale, crop, etc.) a captured original image, input the processed image to a learning model (the MDE estimation model or the AI model), and obtain distance information at all positions in the original image by mapping distance information obtained from the learning model to the original image. Since the resolutions of a sample image and the original image are different, it is not possible to obtain the distance for all pixels of the original image. However, in the present disclosure, since an area where a focus window is set does not need to be in units of pixels, this distance information can be considered sufficient.

Through these various methods of measuring a relative distance or an absolute distance, the distance measurer 130 may obtain distance information at various positions in the captured image. Accordingly, a plurality of positions (P1, P2, P3) having the same distance information can be identified.

The window setter 130 may set a plurality of focus windows (FW1, FW2, FW3) in the captured image based on the positions (P1, P2, P3) having the same distance information in the image. Referring to FIG. 3, a first focus window FW1 may be set in a captured image by a user command through the user interface 160 or by a conventional auto-focusing algorithm. At this time, the window setter 130 may identify other positions P2 and P3 having the same distance information as a position P1 (e.g., a center position) of the first focus window FW1 in the image 10a through the distance measurer 130. In this case, the window setter 130 also may also set focus windows FW2 and FW3 at the positions P2 and P3. The size of the focus windows FW2 and FW3 may be the same as or different from the size of the first focus window FW1. In particular, the focus windows FW1, FW2 and FW3 may be spaced apart from each other without overlapping each other.

Next, the focus position estimator 150 may determine a single focus position FP for capturing the image by analyzing pixels within the focus windows FW1, FW2 and FW3. Here, since the same distance information of the focus windows FW1, FW2 and FW3 has already been obtained, faster focus position estimation is possible. In addition, since pixel information can be obtained from a plurality of focus windows FW1, FW2 and FW3 rather than from a single focus window FW1, that is, since a relatively large amount of data is used for auto-focusing, more accurate focus position estimation is also possible.

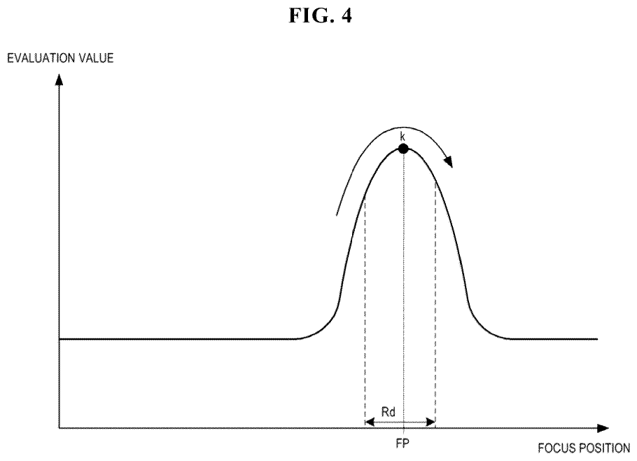

For example, referring to FIG. 4, the focus position estimator 150 may set a selected range Rd that includes a focus position corresponding to the distance information and may search for an optimal focus position with a largest evaluation value while the lens 113 of the imaging device 110 is moved within the selected range Rd by the lens controller 117.

In order to identify the focus position corresponding to the distance information, locus data, which is provided as characteristic information or specification information of the imaging device 110, is required. The locus data may be stored in the storage 105 and then provided to the focus position estimator 150.

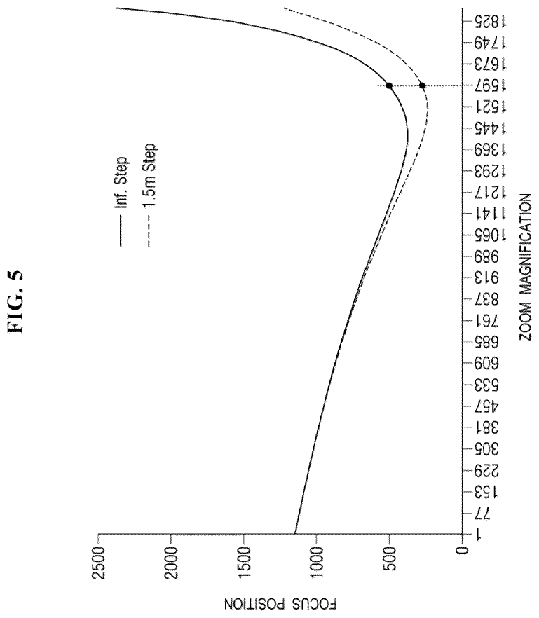

FIG. 5 is an example of locus data indicating the relationship between zoom magnification, focus position, and distance information. FIG. 5 shows only locus data (solid line) at an infinite distance (Inf) and locus data (dotted line) at a distance of 1.5 meters. Here, the horizontal axis represents zoom magnification, and the vertical axis represents focus position. For example, at a position where the zoom-in magnification is 1597, the focus position at a distance of 1.5 meters is about 300, and the focus position at the infinite distance is about 500. Thus, it can be seen that at a zoom-wide position where the zoom magnification is small, a change in focus position relative to a change in distance is small, whereas at a zoom-tele position where the zoom magnification is large, the change in focus position relative to the change in distance is considerably large.

When the selected range Rd is set as described above, the focus position estimator 150 may continuously check a change in the evaluation value while the focus position of the lens 113 moves. Here, pixel information for obtaining the evaluation value may be obtained from a plurality of focus windows (FW1, FW2, FW3). The focus position estimator 150 may find a final peak point k while minutely moving the focus position within the selected range Rd, and the focus position FP at this peak point k may be set as an optimal focus position. Contrast data or edge data may generally be used as the evaluation value. The contrast data may be defined as the sum of difference values (sum of absolute differences (SAD)) between a pixel in an area of interest and its surrounding pixels. The larger this value is, the more edge data or image details there is. In general, the edge data has a higher value as the focus is more accurate.

When the focus position estimator 150 determines a single focus position FP through the above process, the lens controller 117 of the imaging device 110 may control the position of the lens 105 according to the determined focus position FP. Then, the image sensor 115 may obtain an image in an optimal focus state by capturing an image of the subject again after the lens 105 is positioned at the controlled position.

Apart from the first embodiment described above, the second embodiment having both the first mode for estimating a focus position based on a single focus window and the second mode for estimating a focus position based on a plurality of focus windows depending on the determined type of the image may also be considered. According to the second embodiment of the present disclosure, the camera device 100 may further include the image determinator 120 that determines the type of an image captured by the image sensor 115.

Accordingly, the focus position estimator 150 may determine the single focus position using the plurality of focus windows (FW1, FW2, FW3) only when the determined type of the image satisfies a predetermined condition and may determine the single focus position using a single focus window (FW1) when the determined type of the image does not satisfy the predetermined condition.

The predetermined condition refers to a case where there is no choice but to set the size of a focus window small according to the type of the image, that is, a case where the necessity or efficiency of using a plurality of focus windows increases. In other words, the predetermined condition may correspond to a condition that requires using a plurality of focus windows to achieve a threshold level of image quality. For example, the predetermined condition may be a condition where the image is captured in a low-illumination environment. Since the image captured in the low-illumination environment has a lot of noise and lacks necessary image information, it may be difficult to achieve accurate focusing with only a single focus window. Therefore, the necessity of using a plurality of focus windows increases.

The low-illumination condition may be determined using an illumination sensor (such as CdS) or a sensor gain value which is a parameter stored together with a captured image. Alternatively, signal-to-noise ratio (SNR), clip count, luminance distribution, etc. may be used to determine the low-illumination condition.

When the illumination sensor is used as the predetermined condition, if an illumination sensor value when the image is captured exceeds a selected reference value, sufficient image information (e.g., edge information, high-frequency components) can be obtained with only a single focus window. Therefore, in this case, a focus position may be determined using a single focus window. This can reduce the amount of computation required when a plurality of focus windows are used.

On the other hand, if the illumination sensor value when the image is captured does not exceed the selected reference value, sufficient image information can be obtained with only a single focus window. Therefore, in this case, the focus position may be determined using a plurality of focus windows despite an increase in the amount of computation. This can prevent inaccurate lens focusing due to insufficient image information.

Similarly, when the sensor gain value (one of the parameters stored in a camera) is used as the predetermined condition, if the sensor gain value does not exceed a selected reference value, a focus position may be determined using only a single focus window. In general, the sensor gain value may be inversely proportional to the illumination sensor value. Therefore, a low sensor gain value means that illumination was sufficient when the image was captured.

On the other hand, if the illumination sensor value when the image is captured exceeds the selected reference value, it means that illumination was not sufficient when the image was captured. Therefore, the focus position may be determined using a plurality of focus windows.

In this way, for an image captured under the low-illumination condition, focus position estimation may be performed using all of the focus windows (FW1, FW2, FW3). However, pixel information below a certain luminance level may be almost meaningless due to the nature of the low-illumination condition. Therefore, the focus position estimation may be performed using only a single focus window with a largest luminance value among the selected focus windows (FW1, FW2, FW3) to determine the focus position FP.

The predetermined condition may mean a zoom-wide condition (a condition in which an image is captured at a low magnification) together with or separately from the low-illumination condition (a condition in which an image is captured in a low-illumination environment). The zoom-wide magnification may be determined through lens data such as auto-focusing (AF) window data or zoom magnification.

According to an embodiment, the predetermined condition for image determination may be satisfied when a user inputs a command to focus on a specific area of interest within the image through the user interface 160. In some examples, the predetermined condition may be satisfied when a command to focus only on an object whose motion has been detected by a motion detection algorithm is input.

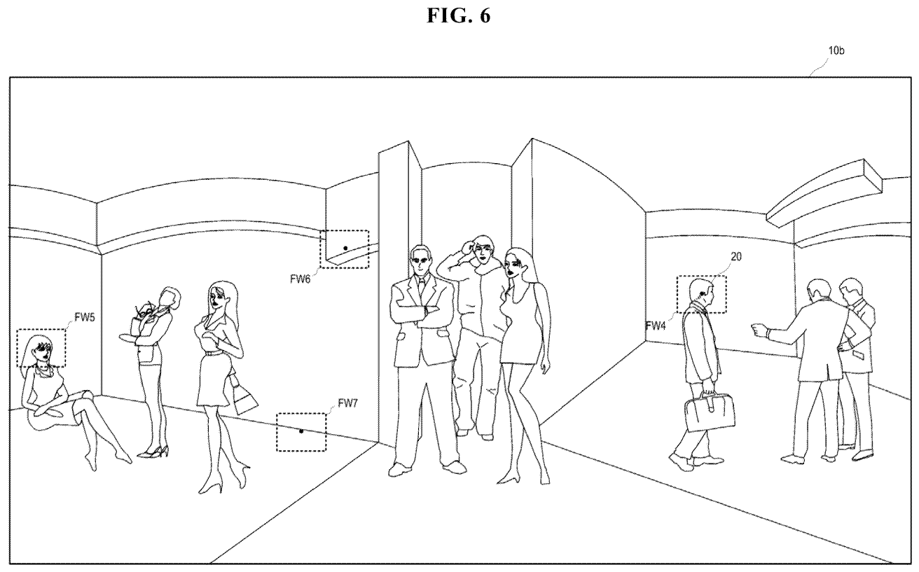

An area of interest desired by a user may often be an area of a very small object within an image (see 10b of FIG. 6) or an area of a partially obscured object. Therefore, in many cases, it may not be possible to secure a sufficiently large focus window. Therefore, in this case, the distance measurer 140 may obtain distance information of an object of interest 20 designated by the user and identify other areas at the same distance as the object of interest 20. Then, the window setter 130 may not only set a focus window FW4 at the position of the object of interest, but also set focus windows FW5, FW6 and FW7 in the other areas (see FIG. 6).

In the second embodiment described above, the number of focus windows may be set differently according to the criterion for image determination. However, it may be necessary to set the number of windows differently based on not only the type of an image determined by the image determinator 120, but also the distance information obtained by the distance measurer 140 itself.

That is, even if an image is determined to satisfy the predetermined condition by the image determinator 120, if a distribution value of the distance information calculated by the distance measurer 140 is not suitable for using a plurality of focus windows (e.g., if the distribution value of the distance information is small and thus a difference in distance within the image is small), focus position estimation may be performed using only a single focus window as in the conventional art.

To this end, the distance measurer 130 may calculate a distribution value of a plurality of pieces of distance information within the image. The distribution value is an indicator of how various pieces of distance information are included in the image over a wide range. The distribution value may be expressed as variance or standard variation.

First, when the depth estimation image 13 is obtained according to monocular depth estimation as in FIG. 2, the depth estimation image 13 may be divided into a plurality of blocks 15 as illustrated in FIG. 7. Here, the size of the blocks 15 may be set to the size of a minimum field of view (FoV).

The distribution value may be determined by plotting a luminance value or R/G/B components representing each block 15 on a histogram 17 or by calculating the variance or standard variation. Although a case where distance information is obtained through monocular depth estimation has been described, the distribution value may also be obtained in the same manner for absolute distances obtained through the ToF of electromagnetic waves such as LiDAR or laser. In addition, the representative luminance value may be calculated as an average luminance value, a median luminance value, a luminance value of pixels having brightness continuity, etc. within each block 15.

The distribution value calculated by the distance measurer 130 as described above is provided to the focus position estimator 150. When the calculated distribution value exceeds a reference value, the focus position estimator 150 may determine a single focus position FP using a plurality of focus windows. Conversely, when the calculated distribution value does not exceed the reference value, the focus position estimator 150 may determine the single focus position FP using only a single focus window.

As described above, the present disclosure may set a plurality of focus windows having the same distance and extract more image information from the focus windows, thereby enabling more accurate focus setting in a camera device. However, since the amount of image information varies depending on a captured image, the number of focus windows to be set is also one of the important issues. For example, when a plurality of focus windows FW4, FW5, FW6 and FW7 having the same distance are found in FIG. 6, the number of focus windows to be used and the criteria for selecting a focus window to use first may be key issues. If too few focus windows are set, the accuracy of focus setting will decrease, which may directly affect the performance of the camera device. If too many focus windows are set, unnecessary computation may be performed.

Therefore, according to an embodiment of the present disclosure, the number of focus windows may be variably set according to the characteristics of a captured image. To this end, the window setter 130 may variably set the number of focus windows by additionally selecting a plurality of focus windows until the amount of image information obtained from the focus windows exceeds a threshold.

As criteria for selecting a focus window, (1) the amount of high-frequency components included in the focus window and (2) the average brightness of the focus window can be used.

For example, the window setter 130 may include only a focus window having high-frequency components in an amount equal to or greater than a reference value (a focus window having high-frequency characteristics) among the focus windows FW4, FW5, FW6 and FW7 and exclude a focus window having high-frequency components in an amount less than the reference value (a focus window having low-frequency characteristics). The amount of high-frequency components may be generally the same concept as the amount of edge components and can be determined numerically through gradient analysis or discrete cosine transform of a corresponding area. In FIG. 6, four focus windows FW4, FW5, FW6 and FW7 having the same distance exist. However, FW6 and FW7 may be excluded because they are windows having relatively low-frequency characteristics. This is because even image information corresponding to a similar distance can have a negative effect on auto-focusing performance if its characteristics are not good.

In another example, the window setter 130 may set only a focus window whose average brightness is equal to or higher than a reference value among the focus windows FW4, FW5, FW6 and FW7 and may exclude a focus window whose average brightness is lower than the reference value. An image captured in a low-illumination environment, such as at night, may include an area with a lot of noise. Therefore, if the brightness of a focus window is lower than the reference value, even if the focus window has high-frequency characteristics, it cannot be useful information because it is noise and not an actual edge.

There may also be cases where the number of focus windows having the same distance information in a captured image is too small to secure sufficient image information. In this case, the window setter 130 may increase the number of focus windows by additionally securing a plurality of focus windows within a distance range obtained by modifying (adding or subtracting) a margin from the same distance information in order to obtain additional image information. The distance range may be defined as a similar distance range that includes an error margin such as an error in a distance value obtained from the distance information or a depth of a focus lens. Even if focusing is performed by considering image information included in focus windows having a small distance difference (within the distance range), the overall auto-focusing performance may not be greatly affected.

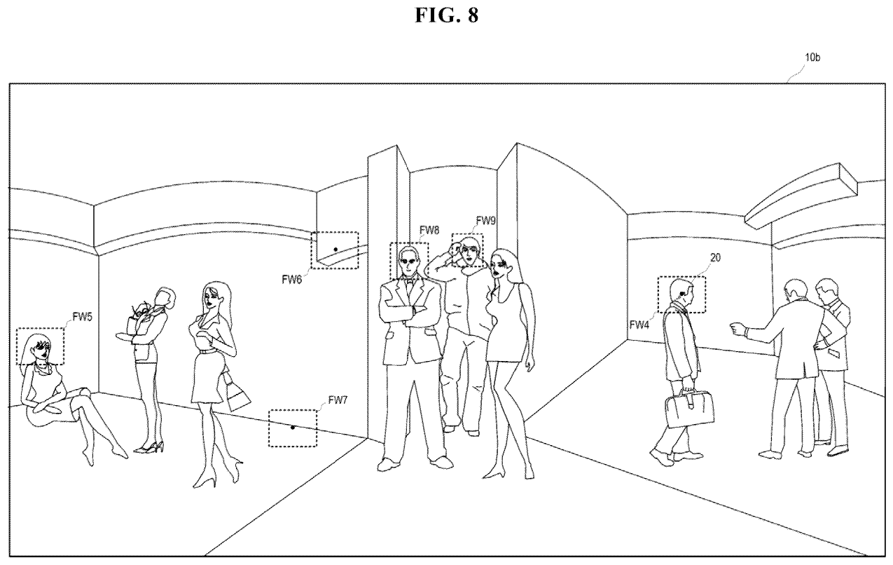

In FIG. 6, four focus windows FW4, FW5, FW6 and FW7 have the same distance information. However, when sufficient image information cannot be secured from the four focus windows, the window setter 130 may set a distance range by adding or subtracting a margin for the distance information. Accordingly, as illustrated in FIG. 8, two focus windows FW8 and FW9 having the same distance information and within the margin range (within the distance range) can be additionally secured. Therefore, the focus position estimator 150 can determine a single focus position for capturing an image by utilizing more image information.

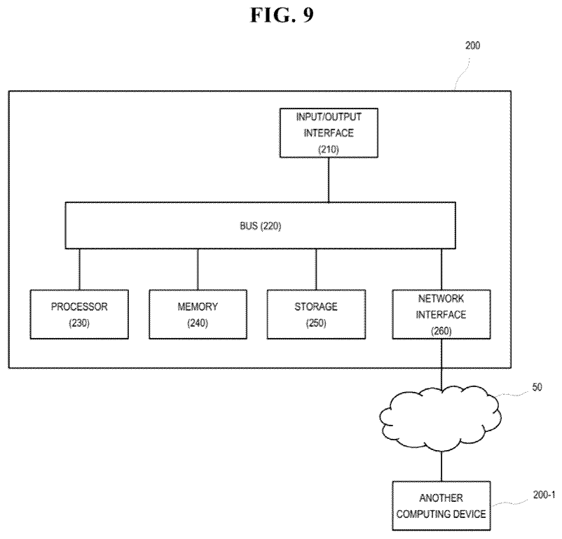

FIG. 9 illustrates the hardware configuration of a computing device 200 that realizes the camera device 100 of FIG. 1.

The computing device 200 may include a bus 220, at least one processor 230, a memory 240, a storage 250, an input/output interface 210, and a network interface 260. The bus 220 may include a data transmission path used by the processor 230, the memory 240, the storage 250, the input/output interface 210, and the network interface 260 to transmit and receive data to and from each other. However, a method of connecting the processor 230, etc. to each other is not limited to bus connection. The processor 230 may include a computational processing unit such as a CPU or a graphics processing unit (GPU), or the like. The memory 240 may include a memory such as a random access memory (RAM) or a read only memory (ROM). The storage 250 may include a storage device such as a hard disk, a solid state drive (SSD), a memory card, or the like. In addition, the storage 250 may include a memory such as a RAM or a ROM.

The input/output interface 210 may include an interface for connecting the computing device 200 to an input/output device. For example, a keyboard or mouse is connected to the input/output interface 210.

The network interface 260 may include an interface for connecting the computing device 200 to an external device so that the computing device 200 can communicate with the external device to transmit and receive transmission packets. The network interface 260 may be a network interface for connecting to a wired line or a network interface for connecting to a wireless line. For example, the computing device 200 may be connected to another computing device 200-1 through a network 50.

The storage 250 may store program modules that implement each function of the computing device 200. The processor 230 may execute each of the program modules to implement each function corresponding to the program module. Here, the processor 230 may execute each of the modules after reading the modules onto the memory 240.

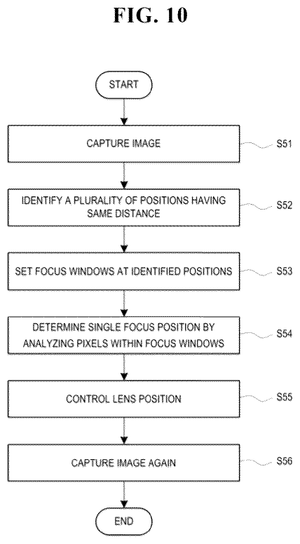

FIG. 10 is a flowchart illustrating a focus setting method performed by a camera device including a processor and a memory that stores program instructions executed by the processor according to an embodiment of the present disclosure.

First, the image sensor 115 may capture an image of a subject using light received through a lens (operation S51).

Next, the distance measurer 130 may identify a plurality of positions (P1, P2) having the same distance information in the image (operation S52).

The window setter 130 may set a plurality of focus windows (FW1, FW2, FW3) in the image based on the positions (operation S53).

The focus position estimator 150 may determine a single focus position FP for capturing the image by analyzing pixels within the focus windows (FW1, FW2, FW3) (operation S54). Finally, the lens controller 117 may control the position of the lens 105 according to the determined focus position FP (operation S55). After the lens 105 is positioned at the position, the image sensor 115 may capture an image of the subject again (operation S56).

According to the present disclosure, it is possible to improve auto-focusing performance by increasing the number of focus windows in the captured image and the amount of data utilized for auto-focusing.

In addition, according to the present disclosure, it is also possible to perform auto-focusing in an optimal mode according to the classification of the captured image captured among a conventional mode for determining a focus position based on a single focus window and a mode for determining a focus position based on a plurality of focus windows.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

1. A camera device comprising:
a lens configured to receive light incident from a subject;
an image sensor configured to capture an image of the subject using the received light;
a distance measurer configured to identify a plurality of positions having same distance information in the image;
a window setter configured to set one or more focus windows in the image based on the plurality of positions;
a focus position estimator configured to determine a focus position for capturing the image using pixels within the one or more focus windows; and
a lens controller configured to control a position of the lens according to the determined focus position.

2. (canceled)

3. The camera device of claim 1, further comprising an image determinator configured to determine a type of the image,
wherein the focus position estimator is further configured to:
determine the focus position using a plurality of focus windows based on the type of the image satisfying a predetermined condition; and
determine the focus position using a single focus window based on the type of the image not satisfying the predetermined condition.

4. The camera device of claim 3, wherein the predetermined condition is satisfied based on the image being captured under a low-illumination condition or at a zoom-wide magnification condition.

5. The camera device of claim 4, wherein the low-illumination condition is satisfied based on an illumination sensor value exceeding a first reference value or based on a sensor gain value being less than or equal to a second reference value.

6. The camera device of claim 1, wherein the distance information comprises at least one of an absolute distance obtained through a time of flight (ToF) of electromagnetic waves, and a distance for each of a plurality of areas within the image that is stored through pre-calibration.

7. The camera device of claim 1, wherein the distance information is obtained through learning of the image, and the image used as input for the learning is an image that is down-sampled from the captured image or cropped from the captured image.

8. The camera device of claim 7, wherein the distance measurer is further configured to obtain the distance information in units of areas or pixels within the captured image by matching the distance information obtained through the learning with the captured image.

9. The camera device of claim 1, wherein the window setter is further configured to variably set a number of focus windows by increasing the number of focus windows until an amount of image information obtained from the one or more focus windows exceeds a threshold.

10. The camera device of claim 9, wherein the window setter is further configured to set the one or more focus windows within a distance range obtained by modifying a margin from the distance information.

11. The camera device of claim 1, wherein the window setter is further configured to set a focus window having high-frequency components in an amount equal to or greater than a reference value as the one or more focus windows, and exclude a focus window having the high-frequency components in an amount less than the reference value.

12. The camera device of claim 1, wherein the window setter is further configured to set a focus window whose average brightness is equal to higher than a reference value as the one or more focus windows, and exclude a focus window whose average brightness is lower than the reference value.

13. The camera device of claim 1, wherein the distance measurer is further configured to calculate a distribution value of a plurality of pieces of distance information within the captured image, and
wherein the focus position estimator is further configured to:
determine the focus position using a plurality of focus windows based on the distribution value exceeding a reference value, and
determine the focus position using a single focus window based on the distribution value being equal to or less than the reference value.

14. A focusing setting method performed by a camera device, the method comprising:
capturing an image of a subject using an image sensor;
identifying a plurality of positions having same distance information in the image;
setting one or more focus windows in the image based on the plurality of positions;
determining a focus position for capturing the image using pixels within the one or more focus windows; and
controlling a position of a lens according to the determined focus position.

15. The method of claim 14, further comprising determining a type of the image, wherein the determining of the focus position comprises:
determining the focus position using a plurality of focus windows based on the type of the image satisfying a predetermined condition; and
determining the focus position using a single focus window based on the type of the image not satisfying the predetermined condition.

16. The method of claim 14, wherein the distance information is obtained through learning of the image, and an image used as input for the learning is an image that is down-sampled from the captured image or cropped from the captured image.

17. The method of claim 14, wherein the setting the one or more focus windows comprises variably setting a number of focus windows by increasing the number of focus windows until an amount of image information obtained from the one or more focus windows exceeds a threshold.

18. The method of claim 17, wherein the setting the one or more focus windows further comprises setting the one or more focus windows within a distance range obtained by modifying a margin from the distance information.

19. The method of claim 14, wherein the setting the one or more focus windows comprises setting a focus window having high-frequency components in an amount equal to or greater than a reference value as the one or more focus windows, and excluding a focus window having the high-frequency components in an amount less than the reference value.

20. The method of claim 14, wherein the setting the one or more focus windows comprises setting a focus window whose average brightness is equal to higher than a reference value as the one or more focus windows, and excluding a focus window whose average brightness is lower than the reference value.

21. A non-transitory computer-readable storage medium storing instructions that, when executed by at least one processor of a camera device, cause the camera device to:
capture an image of a subject using an image sensor;
identify a plurality of positions having same distance information in the image;
set one or more focus windows in the image based on the plurality of positions;
determine a focus position for capturing the image using pixels within the one or more focus windows; and
control a position of a lens according to the determined focus position.
